(19) United States
(12) Patent Application Publication
(10) Pub. No.: US 2019/0042329 A1
(43) Pub. Date: Feb. 7, 2019

(54) SYSTEM WITH PROGRAMMABLE MULTI-CONTEXT ACCELERATOR CIRCUITRY

(71) Applicants: Utkarsh Y. Kakaiya, Folsom, CA (US); Pratik Marolia, Hillsboro, OR (US); Joshua David Fender, East York (CA); Sundar Nadathur, Cupertino, CA (US); Nagabhushan Chitlur, Portland, OR (US); Yuling Yang, Cupertino, CA (US); David Alexander Munday, Santa Cruz, CA (US)

(72) Inventors: Utkarsh Y. Kakaiya, Folsom, CA (US); Pratik Marolia, Hillsboro, OR (US); Joshua David Fender, East York (CA); Sundar Nadathur, Cupertino, CA (US); Nagabhushan Chitlur, Portland, OR (US); Yuling Yang, Cupertino, CA (US); David Alexander Munday, Santa Cruz, CA (US)

(21) Appl. No.: 16/024,563

(22) Filed: Jun. 29, 2018

(51) Int. Cl. G06F 9/50; G06F 13/42

(52) U.S. Cl. CPC G06F 9/5088; G06F 2213/0026; G06F 2209/509; G06F 13/4282

(57) ABSTRACT

A system is provided that includes a host processor coupled to a programmable acceleration coprocessor. The coprocessor may include logic for implementing a physical function and multiple associated virtual functions. The coprocessor may include a static programmable resource interface circuit (PIC) configured to perform management functions and one or more partial reconfiguration regions, each of which can be loaded with an accelerator function unit (AFU). An AFU may further be partitioned into AFU contexts (AFCs), each of which can be mapped to one of the virtual functions. The PIC enables hardware discovery/enumeration and loading of device drivers such that security isolation and interface performance are maintained.

### BACKGROUND

This relates to integrated circuits and, more particularly, to programmable integrated circuits in a hardware acceleration platform.

Programmable integrated circuits are a type of integrated circuit that can be programmed by a user to implement a desired custom logic function. In a typical scenario, a logic designer uses computer-aided design tools to design a custom logic circuit. When the design process is complete, the computer-aided design tools generate configuration data. The configuration data is loaded into memory elements on a programmable integrated circuit to configure the device to perform the functions of the custom logic circuit.

Programmable devices may be used for co-processing in big-data or fast-data applications. For example, programmable devices may be used in application acceleration tasks in a data center and may be reprogrammed during data center operation to perform different tasks. By offloading computationally intensive tasks from a host processor to highly-parallel acceleration resources on a programmable device (sometimes referred to as a co-processor or an acceleration processor), the host processor is freed up to perform other critical processing tasks. The use of programmable devices as hardware accelerators can therefore help deliver improved speeds, latency, power efficiency, and flexibility for end-to-end cloud computing, networking, storage, artificial intelligence, autonomous driving, virtual reality, augmented reality, gaming, and other data-centric applications.

With the substantial increase in the computing power of a single server in cloud data centers in recent years, certain workloads can significantly underutilize the available processing power of the server. This underutilization of available processing capability has spawned the adoption of server virtualization. Server virtualization allows multiple virtual machines (VMs) and containers to run as independent virtual servers on a single host processor/server. In a hardware acceleration platform, a programmable integrated circuit such as a field-programmable gate array (FPGA) device connected to the host processor is physically partitioned into independent regions, each of which is assigned to and serves a corresponding one of the virtual machines or containers. Physically partitioning programmable resources or time multiplexing of physically partitioned resources in this way enables the FPGA device to be used simultaneously by a limited number of virtual machines.

It is within this context that the embodiments described herein arise.

### BRIEF DESCRIPTION OF THE DRAWINGS

FIG. 1 is a diagram of a programmable integrated circuit in accordance with an embodiment.

FIG. 2 is a diagram of an illustrative server that employs hardware acceleration resources in accordance with an embodiment.

FIG. 3A is a diagram showing an illustrative mapping scheme for upstream memory requests in accordance with an embodiment.

FIG. 3B is a diagram showing an illustrative mapping scheme for downstream memory requests in accordance with an embodiment.

FIG. 4 is a flow chart of illustrative steps for performing a context-level reset for a specific accelerator function unit context (AFC) in accordance with an embodiment.

FIG. 5 is a diagram of an illustrative device feature list (DFL) from the perspective of a physical function in accordance with an embodiment.

FIG. 6 is a diagram of an illustrative device feature list (DFL) from the perspective of a virtual function in accordance with an embodiment.

FIG. 7 is a diagram of a virtualized device feature list (DFL) from the perspective of a physical function in accordance with an embodiment.

FIG. 8 is a diagram of a virtualized device feature list (DFL) from the perspective of a virtual function in accordance with an embodiment.

FIG. 9 is a flow chart of illustrative steps for reconfiguring an accelerator function unit (AFU) in accordance with an embodiment.

FIG. 10A is a flow chart of illustrative steps for assigning a virtual function to an AFC in accordance with an embodiment.

FIG. 10B is a flow chart of illustrative steps for removing a virtual function from an AFC in accordance with an embodiment.

### DETAILED DESCRIPTION

The present embodiments relate to methods and apparatus for bridging static device virtualization technologies such as single-root input/output virtualization (SR-IOV) or scalable input/output virtualization (Scalable IOV) to dynamically-reconfigurable programmable integrated circuits. A server may include a host processor that is accelerated using a programmable device such as a programmable logic device (PLD) or a field-programmable gate array (FPGA) device.

The programmable device may include a programmable resource interface circuit (PIC) responsible for programmable resource management functions and may also include one or more accelerator function units (AFUs) that can be dynamically reprogrammed to perform one or more tasks offloaded from the host processor. Each AFU may be further logically partitioned into virtualized AFU contexts (AFCs). The PIC may be a static region for mapping a particular a PCIe (Peripheral Component Interconnect Express) function such as a physical function or a virtual function to one or more AFCs in the programmable device via a virtualized communications interface. The host processor (e.g., host drivers) handles hardware discovery/enumeration and loading of device drivers such that security isolation and interface performance are maintained.

For example, the PIC may include mechanisms that enable the host processor to perform dynamic request/response routing with access isolation (e.g., for handling upstream memory requests from an AFC to the host processor, downstream memory requests from the host processor to an AFC, AFC interrupts, function level resets for an AFC, etc.) and to perform AFC discovery and identification (e.g., using a device feature list with programmable or virtualized device feature headers, updating an AFU/AFC identifier using a received AFU metadata file, etc.). Configured in this way, the virtualized AFCs on a single programmable device can be efficiently scaled to support and interface with more than four virtual machines (VMs) running on the host processor/service, more than 10 VMs, more than 20 VMs, more than 30 VMs, 10-100 VMs, more than 100 VMs, or hundreds/thousands of VMs, process containers, or host processes running on the host server. By using the PIC to create dynamic associations between the host/guest OS and the AFCs via available platform capabilities, the particular platform virtualization capabilities (e.g., SR-IOV or Scalable IOV) may be abstracted from the AFU developer so that the AFU developer sees a consistent interface across platforms.

It will be recognized by one skilled in the art, that the present exemplary embodiments may be practiced without some or all of these specific details. In other instances, well-known operations have not been described in detail in order not to unnecessarily obscure the present embodiments.

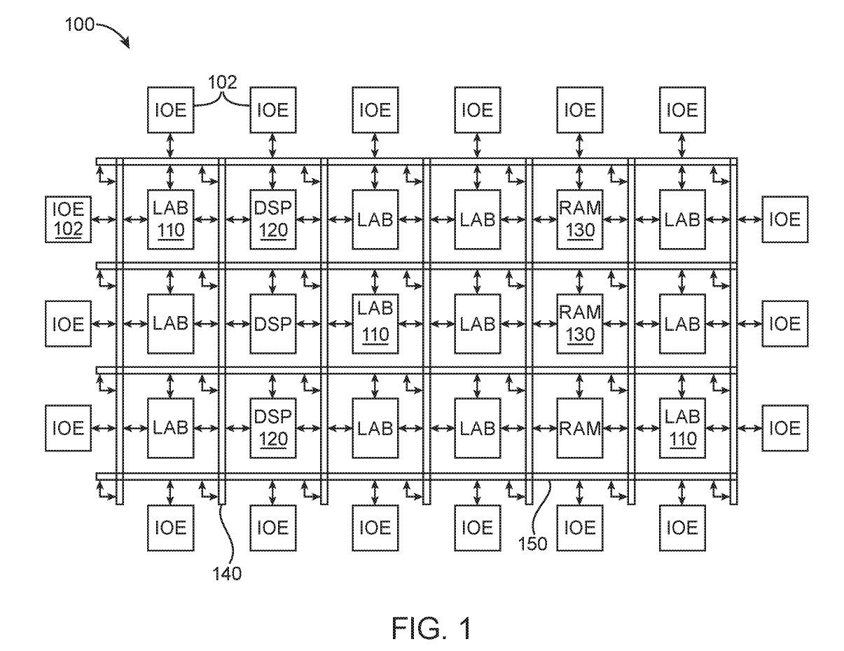

An illustrative embodiment of a programmable integrated circuit such as programmable logic device (PLD) 100 that may be configured to implement a circuit design is shown in FIG. 1. As shown in FIG. 1, device 100 (e.g., a field-programmable gate array integrated circuit die) may include a two-dimensional array of functional blocks, including logic array blocks (LABs) 110 and other functional blocks, such as random-access memory (RAM) blocks 130 and digital signal processing (DSP) blocks 120, for example. Functional blocks such as LABs 110 may include smaller programmable regions (e.g., logic elements, configurable logic blocks, or adaptive logic modules) that receive input signals and perform custom functions on the input signals to produce output signals. LABs 110 may also be grouped into larger programmable regions sometimes referred to as logic sectors that are individually managed and configured by corresponding logic sector managers. The grouping of the programmable logic resources on device 100 into logic sectors, logic array blocks, logic elements, or adaptive logic modules is merely illustrative. In general, device 100 may include functional logic blocks of any suitable size and type, which may be organized in accordance with any suitable logic resource hierarchy.

Programmable logic device 100 may contain programmable memory elements. Memory elements may be loaded with configuration data (also called programming data or configuration bitstream) using input-output elements (IOEs) 102. Once loaded, the memory elements each provide a corresponding static control signal that controls the operation of an associated functional block (e.g., LABs 110, DSP 120, RAM 130, or input-output elements 102).

In a typical scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements. Programmable logic device (PLD) 100 may be configured to implement a custom circuit design. For example, the configuration RAM may be programmed such that LABs 110, DSP 120, and RAM 130, programmable interconnect circuitry (i.e., vertical channels 140 and horizontal channels 150), and the input-output elements 102 form the circuit design implementation.

In addition, the programmable logic device may have input-output elements (IOEs) 102 for driving signals off of device 100 and for receiving signals from other devices. Input-output elements 102 may include parallel input-output circuitry, serial data transceiver circuitry, differential receiver and transmitter circuitry, or other circuitry used to connect one integrated circuit to another integrated circuit.

Device 100 may also include programmable interconnect circuitry in the form of vertical routing channels 140 (i.e., interconnects formed along a vertical axis of PLD 100) and horizontal routing channels 150 (i.e., interconnects formed along a horizontal axis of PLD 100), each routing channel including at least one track to route at least one wire. If desired, the interconnect circuitry may include pipeline elements, and the contents stored in these pipeline elements may be accessed during operation. For example, a programming circuit may provide read and write access to a pipeline element.

Note that other routing topologies, besides the topology of the interconnect circuitry depicted in FIG. 1, are intended to be included within the scope of the present invention. For example, the routing topology may include wires that travel diagonally or that travel horizontally and vertically along different parts of their extent as well as wires that are perpendicular to the device plane in the case of three dimensional integrated circuits, and the driver of a wire may be located at a different point than one end of a wire. The routing topology may include global wires that span substantially all of PLD 100, fractional global wires such as wires that span part of PLD 100, staggered wires of a particular length, smaller local wires, or any other suitable interconnection resource arrangement.

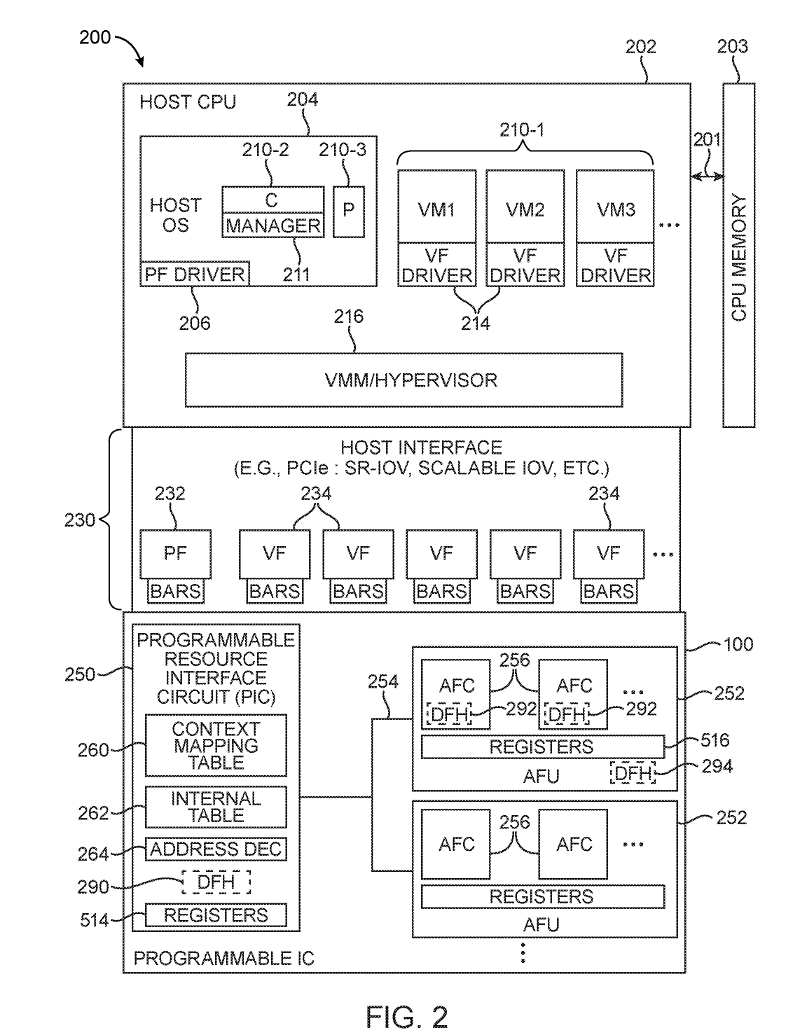

FIG. 2 is a diagram of an illustrative system such as server 200 that employs hardware acceleration resources in accordance with an embodiment. As shown in FIG. 2, server 200 may include a host processor such as central processing unit (CPU) 202 coupled to a programmable device 100. Programmable device 100 may be configured to provide acceleration hardware resources for host CPU 202 and is sometimes referred to as a coprocessor or a reconfigurable acceleration device. Host processor 202 may also be coupled to CPU memory 203 via path 201.

A host operating system (host OS) 204 is loaded on host CPU 202. Host operating system 204 may implement a hypervisor 216 that facilitates the use of one or more virtual machines (VM) 210-1 on host processor 202. Virtual machines are self-contained virtualized partitions that simulate an independent hardware computing resource. Hypervisor 216 may be part of the software or firmware running on host processor 202 and may serve as a virtual machine monitor (sometimes also referred to as a virtual machine manager or VMM) that manages the system's hardware resources so they are distributed efficiently among the virtual machines (VMs) on server 200.

Each virtual machine may be referred to as a guest machine running its own guest operating system (OS). In certain virtualization architectures, a given virtual machine such as VM0 (a VM hosting the host OS 204) may be serve as a parent partition, a control domain (“Domain 0”), or a root partition that manages machine-level functions such as device drivers, power management, and the addition/removal of VMs (e.g., VM0 has a control stack for managing virtual machine creation, destruction, and configuration). The control domain VM0 has special privileges, including the capability to access the hardware directly, handles all access to the system input-output functions, and interacts with any remaining VMs (e.g., VM1, VM2, etc.). Each virtual machine 210-1 may be used to run one or more user applications. Hypervisor 216 presents the VM's guest OS with a virtual operating platform and manages the execution of the guest operating systems while sharing virtualized hardware resources. Hypervisor 216 may run directly on the host's hardware (as a type-1 bare metal hypervisor) or may run on top of an existing host operating system (as a type-2 hosted hypervisor). If desired, additional virtualization drivers and tools (not shown) may be used to help each guest virtual machine communicate more efficiently with the underlying physical hardware of host CPU 202 or the hardware acceleration resources provided by programmable device 100. In general, processor 202 may be configured to host at least two VMs, two to ten VMs, more than 10 VMs, 10-100 VMs, more than 100 VMs, or any suitable number of virtual machines.

In addition to hosting virtual machines 210-1, CPU 202 may also host one or more containers 210-2 (sometimes referred to as process containers). In contrast to a virtual machine 210-1 that has a full guest OS with its own memory management, device drivers, and daemons, containers 210-2 share the host OS 204 and are relatively lighter weight and more portable than VMs. Containers 210-2 are a product of “operating system virtualization” and allow running multiple isolated user-space instances on the same host kernel (i.e., the host kernel is shared among the different containers each running its own workload). This isolation guarantees that any process inside a particular container cannot see any process or resource outside that container.

Similar to what hypervisor 216 provides for VM 210-1, a container manager/engine 211 in the user space may be used to run one or more containers 210-2 on server 200. Container manager 211 presents the isolated container applications with a virtual operating platform and manages the execution of the isolated container applications while sharing virtualized hardware resources. In general, processor 202 may be configured to host at least two containers, two to ten containers, more than 10 containers, 10-100 containers, 100-1000 containers, thousands of containers, or any suitable number of containers sharing the same host OS kernel. As examples, host CPU 202 may be configured to host process containers such as Docker, Linux containers, Windows Server containers, and/or other types of process containers. In other suitable embodiments, host CPU 202 may be configured to host machine containers such as Hyper-V containers developed by Microsoft Corporation, Kata containers managed by the OpenStack Foundation, and/or other types of light-weight virtual machines.

Furthermore, CPU 202 may host one or more processes 210-3 (sometimes referred to as host or application processes), which is similar to a container 210-2 in the sense that a process 210-3 has its own address space, program, CPU state, and process table entry. In contrast to container 210-2 which encapsulates one isolated program with all of its dependencies in its filesystem environment, process 210-3 does not encapsulate any of the dependent shared libraries in the filesystem environment. Process 210-3 can be run on top of the OS. In general, processor 202 may be configured to host at least two processes 210-3, two to ten processes, more than 10 processes, 10-100 processes, 100-1000 processes, thousands of processes, or any suitable number of processes on the kernel.

In general, the software running on host CPU 202 may be implemented using software code stored on non-transitory computer readable storage media (e.g., tangible computer readable storage media). The software code may sometimes be referred to as software, data, program instructions, instructions, script, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of host processor 202.

Host processor 202 may communicate with programmable device 100 via a host interface such as host interface 230. Host interface 230 may be a computer bus interface such as the PCIe (Peripheral Component Interconnect Express) interface developed by the PCI Special Interest Group or PCI-SIG, Cache Coherent Interconnect for Accelerators (CCIX), Gen-Z, Open Coherent Accelerator Processor Interface (OpenCAPI), Intel Accelerator Link (IAL), Nvidia's NVLink, or other computer bus interfaces. In general, host interface 230 may be implemented using other multiple data lane (e.g., at least 2 lanes, at least 4 lanes, at least 8 lanes, at least 16 lanes, at least 32 lanes, at least 64 lanes, etc.), single data lane, parallel data bus, serial data bus, or other computer bus standards that can support data transfer rates of at least 250 MBps (megabytes per second), 500 MBps, 1 GBps (Gigabytes per second), 5 GBps, 10 GBps, 16 GBps, 32 GBps, 64 GBps, or more.

A single host processor 202 running virtual machines 210-1, containers 210-2, host processes 210-3, and other software-level entities (sometimes referred to collectively as “task offloading modules” that offload tasks to programmable accelerator device 100) will need to share host interface 230 among the various types of task offloading modules. To support this, The PCI-SIG has issued an extension to the PCIe specification called single-root input/output virtualization (SR-IOV), which allows the different virtual machines, containers, and software processes in a virtual environment to share a single PCIe hardware interface. The SR-IOV specification enables a single root function (e.g., an Ethernet port) to appear as multiple, separate physical devices, each with its own PCIe configuration space. A physical device with SR-IOV capabilities can be configured to appear in the PCI configuration space as multiple functions on a virtual bus. If desired, the techniques described herein may also be applied to Scalable IOV (SIOV) developed by Intel Corporation or other device virtualization standards.

Intel Scalable IOV is a PCIe-based virtualization technique that enables highly scalable and high performance sharing of I/O devices across isolated domains, while containing the cost and complexity for endpoint device hardware to support such scalable sharing. Depending on the usage model, the isolated domains may be virtual machines, process containers, machine containers, or application processes. Unlike the coarse-grained device partitioning approach of SR-IOV to create multiple VFs on a PF, Scalable IOV enables software to flexibly compose virtual devices utilizing the hardware-assists for device sharing at finer granularity. Performance critical operations on the composed virtual device are mapped directly to the underlying device hardware, while non-critical operations are emulated through device-specific composition software in the host.

SR-IOV defines two types of host-assignable interfaces or PCI functions spanning the hardware/software interface across programmable device 100 and host OS 204: (1) physical functions and (2) virtual functions. A physical function (PF) such as PF 232 is a full-feature PCIe function that is discovered, managed, and configured like typical PCI devices and has its own independent set of Base Address Registers (BARs). Physical function 232 may be managed by a physical function driver 206, which may be part of the kernel space of host OS 204. Physical function 232 configures and manages the SR-IOV functionality by assigning associated virtual functions (VFs) 234. Physical function 232 is therefore sometimes referred to as a “privileged” host-assignable interface. A single physical function 232 can have more than 10, more than 100, up to 256, more than 1000, more than 60000, more than 100000, or at least a million associated virtual functions 234. If desired, each host may also have more than one associated physical function 232.

In contrast to physical function 232, virtual functions 234 are light-weight PCIe functions (i.e., less complex than a PF) that can only control its own behavior. Each virtual function is derived from and share the resources of an associated physical function. Each virtual function 234 may also have its own independent set of Base Address Registers (BARs) and may be managed by a virtual function driver 214 (which is part of the kernel space of the guest OS running on one of the virtual machines 210-1), a user mode driver (which is part of the user space of the program running on one of the containers), or a user mode driver (which is part of the user space of the program running as part of one of the application processes 210-3). In other words, a virtual function may also be assigned to a container 210-2 for enabling hardware offload. In other scenarios, the virtual function BARs are mapped to the address space of process 210-3 to allow hardware submission. In contrast to the physical function which is considered a privileged host-assignable interface, virtual function 234 is therefore sometimes referred to as an “unprivileged” host-assignable interface. In general, each virtual machine 210-1, container 210-2, or process 210-3 can map to one or more virtual functions. Configured in this way, virtual functions have near-native performance and provide better performance than para-virtualized drivers and emulated access and also increases virtualized guest density on host servers within a data center.

Programmable device 100 may include logic to implement physical function 232 and virtual functions 234. Still referring to FIG. 2, programmable device 100 may include a programmable resource interface circuit (PIC) 250 that is coupled to one or more accelerator function units (AFUs) via a virtualized communications interface 254. Interface circuit 250 (sometimes referred to as an FPGA interface unit or FIU) is configured as a static logic portion that provides basic infrastructure functionality such as memory access isolation, device management, and host/memory interfacing.

Programmable device 100 may also include one or more user-programmable regions that can be dynamically and partially reconfigured based on user requests or workload needs. The process where only a subset of programmable logic on device 100 is loaded is sometimes referred to as “partial reconfiguration.” Each of these partial reconfiguration (PR) regions may serve as a “slot” or container in which an accelerator function unit (AFU) 252 can be loaded. Accelerator function unit 252 is used for offloading a computation operation for an application from host CPU 202 to improve performance. As described above, physical function 232 is primarily responsible for management functions. Thus, the dynamic programming of AFU 252 may be supervised by the physical function driver. The example of FIG. 2 in which programmable device 100 is loaded with two AFUs 252 is merely illustrative. In general, device 100 may be provided with only one AFU, more than two AFUs, 2-10 AFUs, more than 10 AFUs, 10-100 AFUs, or any suitable number of accelerator function units. Each of the AFUs 252 on a device 100 may be provided with the same or with a different number of AFCs 252.

In accordance with an embodiment, an AFU region 252 may be further logically subdivided into different AFU contexts (AFCs) 256, each of which serves as a separate unit of acceleration that can be independently assigned to a corresponding distinct software offloading entity such as VM 210-1, container 210-2, or host process 210-3. In general, each task offloading entity may map to one or more virtual functions.

Each AFC 256 may be a slice of the same accelerator (e.g., as part of the same AFU), a completely different accelerator (e.g., as part of different AFUs), a set of portal registers for enabling work submission to shared accelerator resources, or other logical division. For example, a compression AFU with eight engines could expose the AFCs as spatially shared (i.e., exposing each of the 8 compression engines as a distinct AFC), or temporally shared (i.e., exposing a set of portal/doorbell registers that allows descriptor submission to actual engines that are time-shared or time-multiplexed between different AFCs).

In general, all AFCs 256 within an AFU 252 are reconfigured together and are connected to PIC 250 via a single communications interface 254. The PF driver in the host enumerates programmable device 100 and manages PIC 250. The host drivers collectively identify the different AFCs and create associations between the hardware associated with each AFC and the corresponding user application software/driver. As an example, one AFC 256 may be mapped to one virtual function 234 or physical function 232. This is merely illustrative. As another example, multiple AFCs 256 (which may be part of the same AFU or different AFUs) can be mapped to one VF 234. If desired, one AFC 256 might also be mapped to two or more virtual functions.

The example described above in which an AFC is mapped to a PCIe physical function or a PCIe SR-IOV virtual function is merely illustrative. In general, an AFC may be mapped to any host-assignable interface such as Scalable IOV Assignable Device interface (ADI) or other host-assignable interfaces associated with non-PCIe host interfaces.

To support the logical subdivision of an AFU 252 into multiple AFCs 256, communication interface 254 may be virtualized to support AFU sharing. In particular, all transactions crossing interface 254 may be tagged with a context identifier (ID) tag. This context ID tag is used to ensure proper routing of requests and responses between the software applications on the host and the AFCs as well as providing security isolation.

In one suitable arrangement, the context ID tag may be used to provide address isolation between different AFC memory requests. All “upstream” requests from an AFC 256 (e.g., memory requests from an AFC to the host CPU) are tagged with a context_id, which expands the namespace of each memory request to <context_id, address>, where address might represent the physical address or the virtual address. PIC 250 may map the specific context_id to a platform specific identifier using a context mapping table 260. After SR-IOV is enabled in the physical function, the PCI configuration space of each virtual function can be accessed by the bus, device, and function number of that virtual function (sometimes referred to collectively as the “BDF number”).

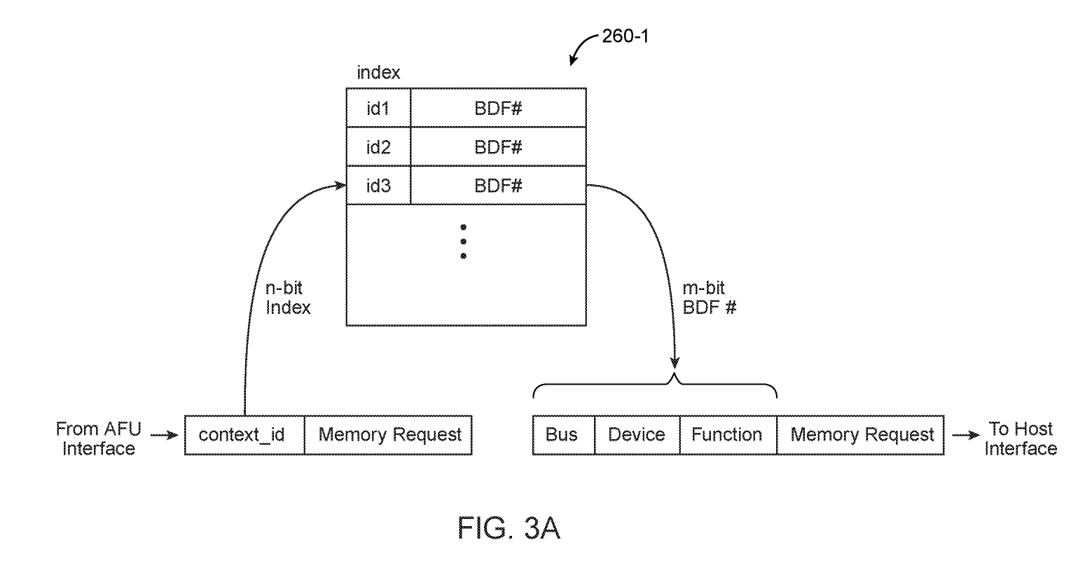

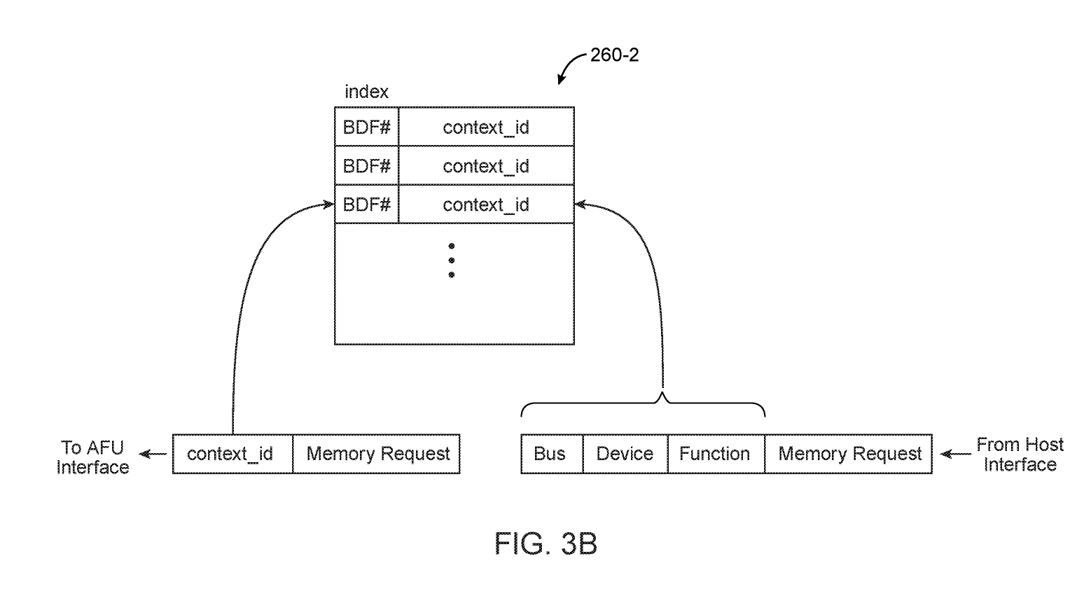

FIG. 3A shows a context mapping table 260-1 where the context_id of an upstream memory request can be used as an index to look up a corresponding PCIe {Bus, Device, Function} number. Each AFC has a unique context_id, which maps to a corresponding PCIe function in accordance with the assigned BDF number. As described above, multiple AFCs may be mapped to one virtual function. The corresponding BDF number in table 260-1 may be appended to the PCIe transport layer packet and sent to the host processor for further processing. If server 200 implements Scalable IOV (SIOV) support or Shared Virtual Memory (SVM) support, then the context_id in the upstream memory request may be mapped to a corresponding PCIe {Bus, Device, Function, PASID} number, where PASID is the process address space ID.

In any case, PIC 250 provides a level of abstraction to each AFU 252 and is responsible for converting the memory request namespace. Operating a virtualized acceleration platform in this way provides the technical advantage of decoupling an AFU's communication semantic from the underlying platform semantics (e.g., from PCIe specific semantics). In general, context_id should be wide enough to only cover the number of supported AFCs, which is likely to be much less than the platform namespace identifier width. Reducing or minimizing the size or bit-width of context_id can save invaluable wire space on device 100.

A response from the host CPU to an upstream request from an AFC or an MMIO transaction initiated by the host needs to be routed back to that AFC. This routing mechanism may depend on how the AFCs are connected to the PCIe physical and virtual functions. In a first mode, at least some or perhaps all of the AFCs are associated with the physical function and accessed through the physical function. The first mode is therefore sometimes referred to as the “PF mode.” In a second mode, each AFC is associated with a single virtual function, and all host communications for an AFC happens through the associated virtual function. The second mode is therefore sometimes referred to as the “VF mode.” The system may also be operated in a third (mixed) mode, where some AFCs are mapped to the physical function while other AFCs are mapped to corresponding virtual functions.

In the PF mode, the physical function's BDF number is used for multiple AFCs, so the BDF number by itself cannot determine the context_id. To address this issue in the PF mode, PCIe has a mechanism whereby a request can be associated with a tag, and the response is guaranteed to return the same tag. For example, the context_id of the request can be saved in an internal table (see, e.g., table 262 in FIG. 2) that is indexed by the PCIe tag when the upstream request is sent. When processing the response, the returned PCIe tag can be used to look up internal table 262 to retrieve the correct context_id. This internal table need not be exposed to the host software and can be updated and read by PIC 250.

In the VF mode, given the PCIe BDF number of the virtual function, PIC 250 can uniquely determine the context_id of the AFC. For “downstream” requests (e.g., memory requests from the host CPU back to an AFC or an MMIO transaction initiated by the host CPU), an inverse context mapping table such as inverse context mapping table 260-2 of FIG. 3B may be used to map a platform-specific identifier (e.g., a BDF number with or without PASID) to a corresponding context_id. Inverse context mapping table 260-2 can be programmed by the host PCIe driver (e.g., PF driver 206) when the entire device 100 is quiesced. Alternatively, a more fine-grained programming of individual AFC entries in table 260-2 may be implemented when the corresponding AFC(s) are quiesced.

Some embodiments may map the AFC namespace to the physical function for host access. In the PF mode (i.e., when all AFCS are mapped to the physical function), all requests such as memory-mapped input/output (MMIO) requests will use the same platform-specific identifier. In this case, the MMIO address range of the physical function will have to be big enough to map the total MMIO space across all AFCs. An additional address decoder such as address decoder 264 provided as part of PIC 250 can then be used to decode the context_id from a given MMIO address associated with the physical function BAR. If desired, address decoder 264 can also be formed as part of an AFU for decoding AFU addresses and/or part of an AFC for decoding AFC addresses. In the mixed mode where some AFCs are mapped to the physical function and other AFCs are mapped to virtual functions, storing a tag in internal table 262, using an inverse mapping table to identify platform-specific identifiers, using address decoder 264 to decode an MMIO address, and/or some combination of these techniques may be used simultaneously.

Similar to issuing upstream memory requests, AFCs can optionally issue interrupts. Interrupt requests from an AFC are also tagged with a context_id, which is handled in a similar way as the upstream request flow shown and described in connection with FIG. 3A. In other words, an interrupt request may have a context_id for looking up a corresponding platform-specific identifier in accordance with context mapping table 260-1.

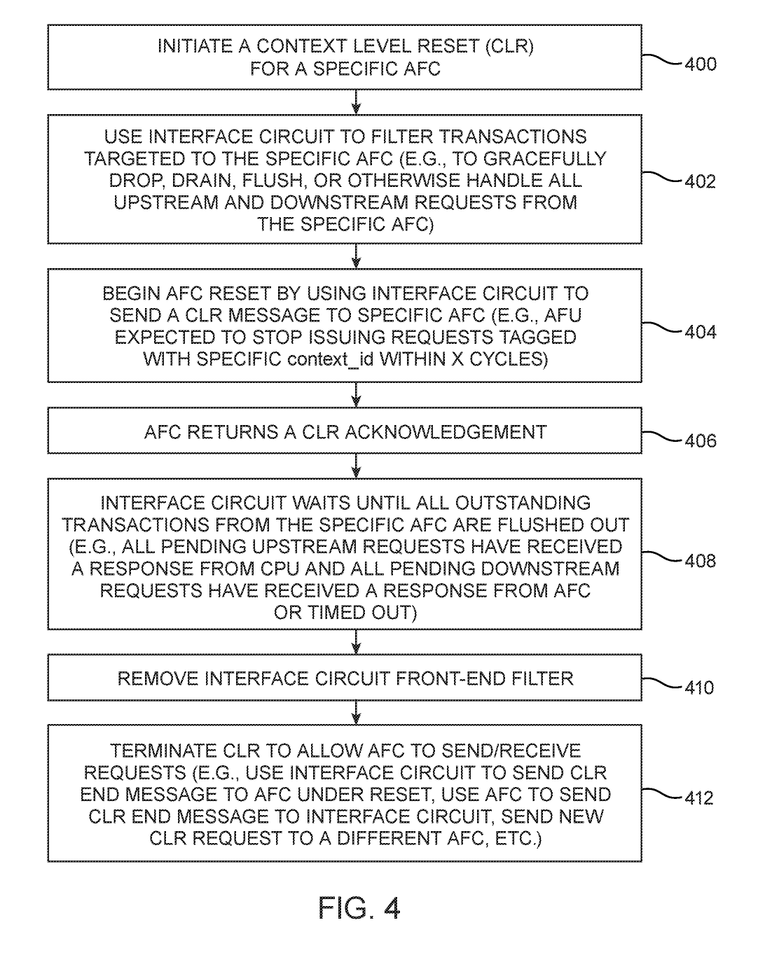

Certain specifications such as SR-IOV require devices to support function-level reset (FLR) per virtual function. In some scenarios such as during the PF mode or the mixed mode, there could be device management registers which are utilized to trigger context-level reset (CLR) for one or more AFCs. The context-level reset might also be initiated via a function-level reset. Moreover, updates to context mapping table 260 also require a way to quiesce corresponding affected AFCs. FIG. 4 is a flow chart of illustrative steps for performing a context-level reset for a specific AFC.

At step 400, a virtual function may initiate a context-level reset (CLR) on a specific AFC. At step 402, a front-end module in PIC 250 may be used to filter transactions targeted to the specific AFC. For example, PIC 250 may be directed to gracefully drop, drain, flush, or otherwise handle all upstream requests from the specified AFC and/or gracefully drop/drain/flush or otherwise handle all downstream requests targeted to the specific AFC. At step 404, the AFC reset may begin by using PIC 250 to send a CLR message to the specific AFC. In response to receive the CLR message, the specific AFC is expected to stop issuing requests tagged with the specific context_id within X cycles (e.g., within 1-2 clock cycles, 1-5 clock cycles, 1-10 clock cycles, 10-100 clock cycles, etc.). At step 406, the AFC may optionally return a CLR acknowledgement back to PIC 250.

At step 408, PIC 250 may wait until all outstanding transactions from the specific AFC are flushed out (e.g., until all pending upstream requests have received a response from the host CPU and until all pending downstream requests have received a response from the AFC or have timed out). At step 410, the front-end transaction filtering of PIC 250 described in connection with step 402 may be removed or suspended.

At step 412, the CLR operation may be terminated by allowing the specific AFC to resume sending and receiving requests to and from the host CPU. To end a specific CLR, PIC 250 may send a CLR end message to the specific AFC under reset, the specific AFC under reset may send a CLR end message to PIC 250, or PIC 250 may send a new CLR request to a different AFC (assuming PIC 250 can only handle one AFC reset at any given point in time).

The steps of FIG. 4 are merely illustrative and are not intended to limit the scope of the present embodiments. If desired, at least some of the existing steps may be modified or omitted; some of the steps may be performed in parallel; additional steps may be added or inserted; and the order of certain steps may be reversed or altered. If desired, other ways of implementing CLR for a multi-context AFU may be used.

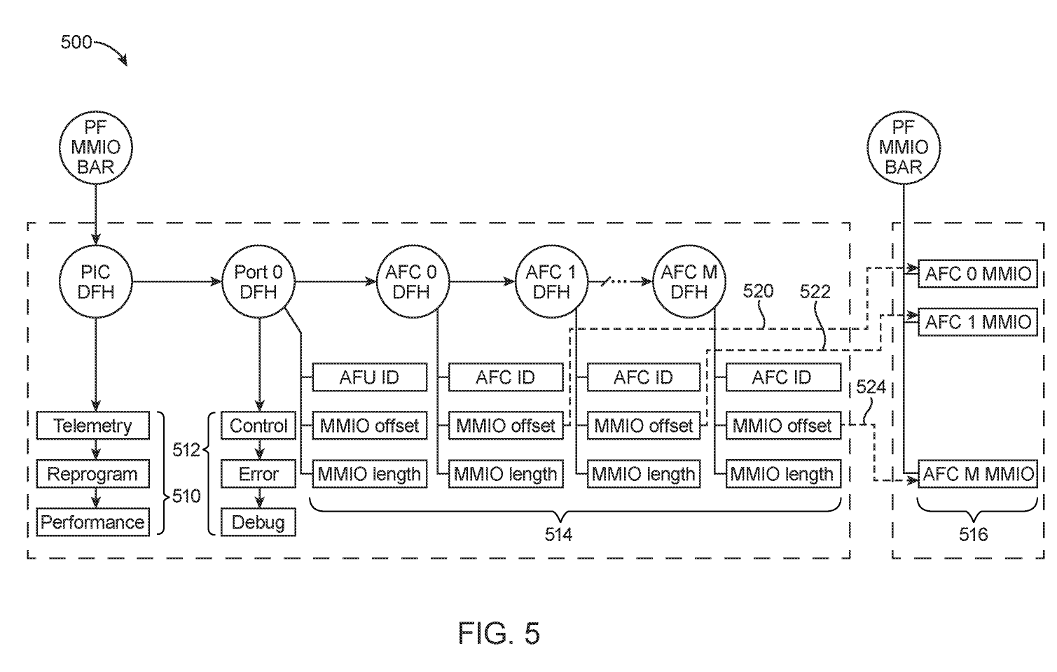

In accordance with another embodiment, programmable device 100 may be configured to maintain a device feature list (DFL) that allows host CPU 202 or the software running on host CPU 202 to discover, enumerate, and identify which AFCs 256 exist on programmable accelerator device 100. In particular, the physical function on the host processor may manage, reprogram, or update the device feature list. The device feature list maps access to particular AFCs to appropriate user applications running on the host CPU (e.g., to allow different AFCs within a single AFU to be shared by multiple user applications). A DFL is a data structure that includes a linked list of device feature headers (DFHs). Each DFH describes a specific sub-feature of device 100. For example, each DFH provides identify information such that the corresponding feature can be discovered by the host software, as well as describing relevant resources and attributes related to that feature. As will be described below in connection with FIGS. 5-8, a single AFU may have one or more associated DFHs.

FIG. 5 is a diagram of an illustrative device feature list 500 from the perspective of a physical function in the PF mode, in the VF mode, or in the mixed mode. In one suitable arrangement, host CPU 202 may interface with programmable device 100 using a memory-mapped I/O (MMIO) scheme. In general, the device feature list is implemented in the programmable logic of device 100 and is exposed to the host via a base address register (BAR). As shown in FIG. 5, MMIO base address register (BAR) associated with the physical function maps to all of the DFH nodes and has a complete view of the accelerator system. The PF driver can walk through the device feature list to enumerate all port and AFC DFHs. In particular, the PF MMIO BAR points to a PIC DFH, which exposes management registers 510. Registers 510 may, for example, include registers for telemetry (e.g., registers for exposing errors and events to the host for monitoring and management purposes), registers for re-programming specific AFU slots, registers containing resettable performance counters and metrics, and other registers meant for general PIC management.

The PIC DFH may point to a Port-0 DFH, which exposes port control registers 512. Registers 512 are port-level registers for controlling the interface between the PIC and a corresponding PR region/slot. Registers 512 may, for example, include registers for programming Port-0, registers for controlling the type of ingress and egress data packets through Port-0, registers for signaling errors, registers used for debug or troubleshooting purposes, or other registers meant for management functions specific to Port-0. If desired, the PIC DFH may also point to DFHs associated with other ports (e.g., Port-1 DFH, Port-2 DFH, Port-3, DFH, etc.). The Port-0 DFH may also be used to read an AFU identifier (ID) and the location (e.g., in accordance with the MMIO offset and MMIO length) of corresponding AFU registers in the user partition. The AFU ID may help identify what is loaded in each AFU.

The Port-0 DFH may point to a series of AFC DFHs (e.g., to a first AFC-0 DFH, which points to a second AFC-1 DFH, . . . , which points to a last AFC-M DFH). Each of these AFC DFHs can be used to read the AFC ID and the location (e.g., using the MMIO offset and length information) of corresponding AFC registers 516 in the user partition (see also registers 516 in FIG. 2). For example, the MMIO offset associated with the AFC-0 DFH may serve as a pointer to the start of that AFC's MMIO region in the PF MMIO BAR, as indicated by dotted path 520. As another example, the MMIO offset associated with the AFC-1 DFH serves as a pointer to the start of that AFC's MMIO region in the PF MMIO BAR, as indicated by dotted path 522. As yet another example, the MMIO offset associated with the AFC-M DFH may serve as a pointer to the start of that AFC's MMIO region in the PF MMIO BAR, as indicated by dotted path 524.

The AFC ID may help identify the functionality that is provided by each AFC. For example, the AFC ID may help identify whether a particular AFC implements a security function (e.g., an encryption/decryption engine), a storage function (e.g., a compression/decompression engine), a machine learning function (e.g., a convolutional neural network engine or a deep neural network engine), a networking function (e.g., a network function virtualization engine), etc.

The AFU/AFC ID, MMIO offset, MMIO length, and other control/status information associated with each of the DFHs may be stored in programmable registers 514. Registers 514 and 516 may have read/write access from the physical function (e.g., the AFU/AFC identifier and location information may be updated by the physical function during partial reconfiguration operations or during a VF assignment/removal process). Programmable registers 514 may be formed as part of PIC 250 (see also registers 514 in FIG. 2). Using the PF driver to configure device function list 500 in this way allows the overall system to create linkages between the hardware of the AFU and the software user applications and to create linkages between the hardware of the AFCs and the software AFC applications (e.g., the virtual function drivers and the user mode drivers).

The physical function operates in a host physical address (HPA) space. In contrast, the virtual functions which can be assigned to a VM or a container operates in the guest physical address (GPA) space. Thus, the MMIO offset from the PF's perspective may be different than the MMIO offset from the VF's perspective to avoid gaps in the GPA for instance. For example, consider a scenario in which each AFC is worth one 4K page, so the MMIO offset for AFC-0 might be 0x0000, whereas the MMIO offset for AFC-1 is 0x1000. However, if AFC-1 is assigned to a virtual function, it might be allocated to MMIO offset 0x0000 to avoid opening up holes in the GPA space from the VF's perspective. While registers 514 have read/write access from the perspective of the physical function (i.e., from PF's view), registers 514 have read-only access from the perspective of the virtual functions (i.e., from VF's view).

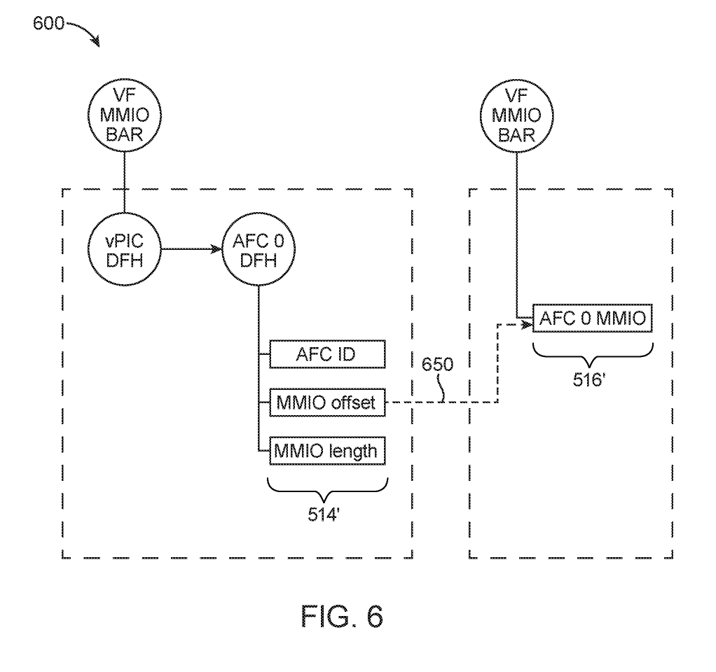

FIG. 6 shows how device feature list 600 appears to a virtual function in the VF mode or in the mixed mode. As shown in FIG. 6, the virtual function has only a limited view of a PIC in the form of a virtual PIC that points to a corresponding AFC DFH. In the example of FIG. 6, the virtual function uses its MMIO BAR to identify a virtual PIC (vPIC) DFH, which points to the AFC-0 DFH. The host driver associated with this particular VF can walk into the AFC-0 DFH to get the AFC ID and location of register 516′ in the user partition, as indicated by path 650. Registers 514′ associated with the AFC-0 DFH for storing the AFC ID, MMIO offset, and MMIO length are read-only registers from the VF's perspective. The example of FIG. 6 in which the VF MMIO BAR maps to the AFC-0 DFH is merely illustrative. In general, the BAR of each distinct virtual function may be mapped to a different respective one of the AFC DFHs in the full device feature list 500 shown in FIG. 5 (e.g., a second virtual function might be mapped to the AFC-1 DFH, a third virtual function might be mapped to AFC-M DFH, etc.).

In the example of FIG. 6, a virtual function sees only one corresponding AFC. If desired, multiple AFCs may be exposed to the same virtual function. To accomplish this, the PF driver can also virtualize the DFH structures. For example, when one or more of the VF MMIO pages are not mapped into second-level (extended) page tables by the VMM, any guest reads/writes to these pages are intercepted and control is transferred to the software component in the host OS (e.g., the PF driver or a virtual device composition module) to emulate whatever DFL/DFH view it needs. In yet another example, the PF driver may allocate the system memory, fill the system memory based on the DFL/DFH view needed, and expose the system memory as the VF MMIO with the help of the VMM (e.g., through the second-level/extended page tables).

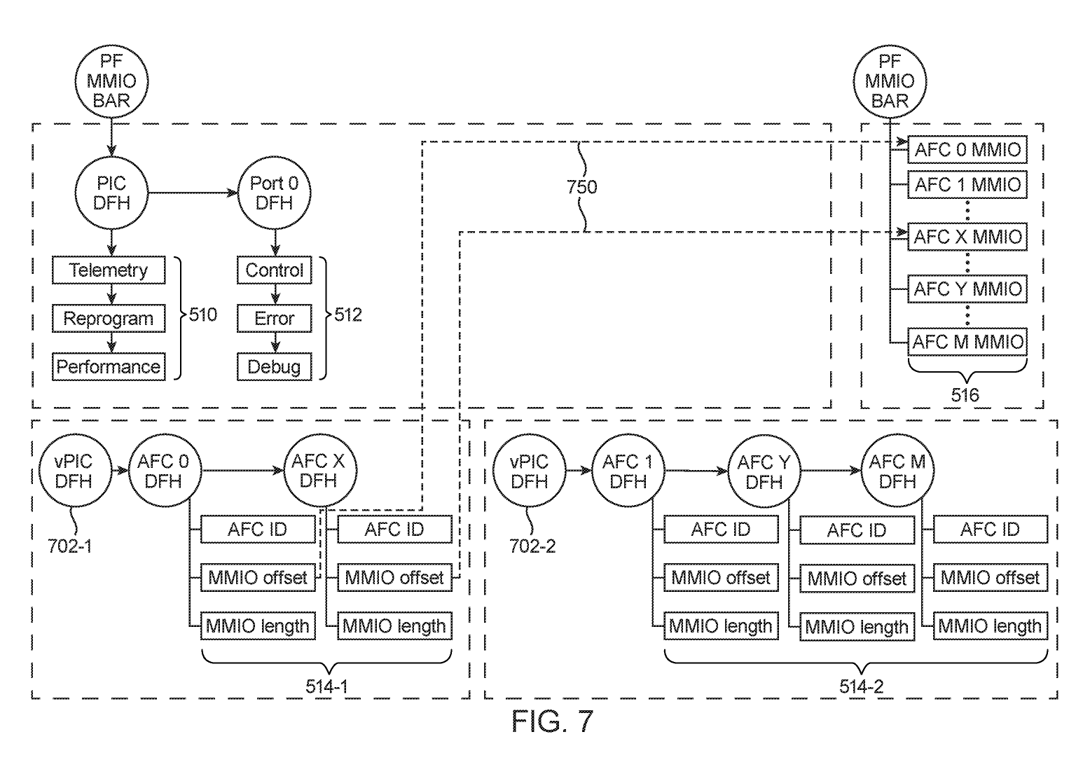

FIG. 7 is a diagram of a virtualized device feature list (DFL) from the perspective of a physical function in the PF mode, in the VF mode, or in the mixed mode. As shown in FIG. 7, the PF MMIO BAR may still point to a PIC DFH, which points to a Port-0 DFH. However, the various AFC DFHs may be referred to using virtualized PIC (vPIC) DFHs. In the example of FIG. 7, a first vPIC DFH 702-1 may be linked to the AFC-0 DFH and the AFC-X DFH, whereas a second vPIC DFH 702-2 may be linked to the AFC-1 DFH, the AFC-2 DFH, and the AFC-M DFH. In particular, the AFC DFHs associated with a given vPIC may map to non-sequential programmable registers 516 in the AFU, as shown by path 750. This technique enables rearrangement of AFC blocks in any manner desired without having to make hardware changes, because the AFC ID, offset, and length information is programmable and virtualized through the system software. Registers 514-1 associated with the first virtualized PIC device 702-1 and registers 514-2 associated with the second virtualized PIC device 702-2 may also be implemented in system memory (see, e.g., CPU memory 203 in FIG. 2). Using the system memory to create the DFL/DFH layout can help reduce area consumption on device 100. If desired, the DFL/DFH layout may also be implemented in private device memory, stolen memory, or other types of external memory. If desired, the AFU DFH may still be implemented as programmable registers in PIC 250.

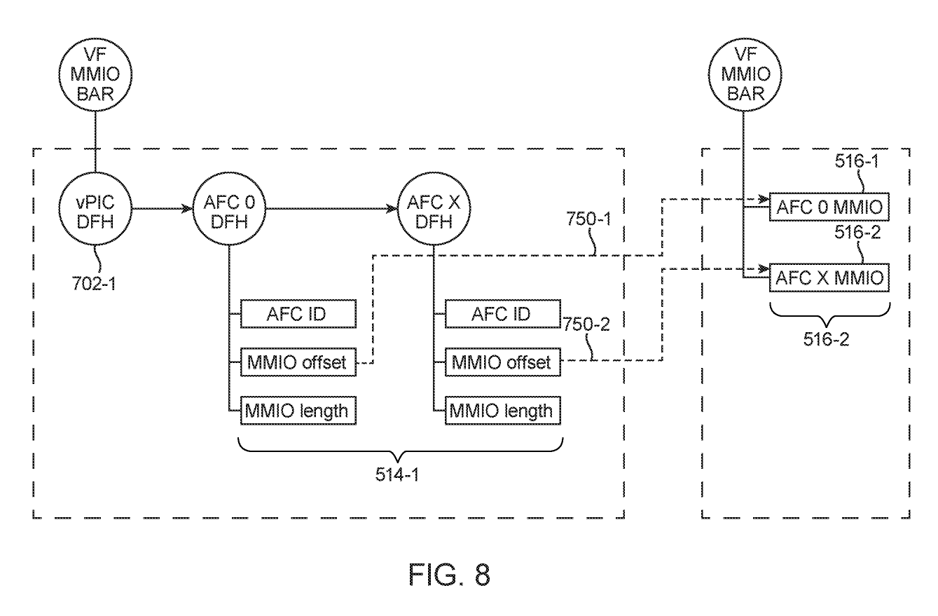

FIG. 8 shows how the virtualized DFH structure of FIG. 7 appears to a virtual function in the VF mode or in the mixed mode. As shown in FIG. 7, the virtual function has only a limited view of a PIC in the form of a virtual PIC that points to one or more corresponding AFC DFHs. In the example of FIG. 8, the virtual function uses its MMIO BAR to identify virtual PIC (vPIC) DFH 702-1, which links to the AFC-0 DFH and to the AFC-X DFH. The host driver associated with this particular VF can walk into the AFC-0 DFH to obtain the AFC ID and location of register 516-1 in the user partition (as indicated by path 750-1) and into the AFC-X DFH to retrieve the AFC ID and location of register 516-2 in the user partition, as indicated by path 750-2. Registers 514-1 associated with the AFC-0 and AFC-X DFHs for storing the AFC ID, MMIO offset, and MMIO length information are read-only registers from the VF's perspective. A similar limited view may be provided for vPIC 702-2, which maps to the AFC-1, AFC-Y, and AFC-M non-sequential DFHs. Other virtual functions (and BARs) for mapping to other subsets of AFCs may also be included.

The various device feature headers (DFHs) described above are generally implemented using programmable DFH registers on device 100. With the addition of context_id tags to transactions traverse communications interface 254, the DFH registers will have to take these tags into account. In one suitable arrangement, the PIC DFH and optionally the Port-0 DFH (referred to collectively as the “AFU DFH”) may be implemented as a programmable register in PIC 250 (see, e.g., DFH register 290 in FIG. 2), whereas the AFC DFHs are implemented as DFH registers accessible via requests sent over interface 254 tagged with their corresponding context_id (see, e.g., DFH registers 292 in FIG. 2).

In another suitable arrangement, the AFU DFH is contained within the AFU (see, e.g., AFU DFH register 294 in FIG. 2) and is accessible through a special interface. This special interface may be an independent interface, a special transaction, or mapped to a special context_id tag such as 0 or −1. The AFC DFHs may again be implemented as registers 292 within each AFC and are accessible via requests sent through interface 254 tagged with their corresponding context_id tag.

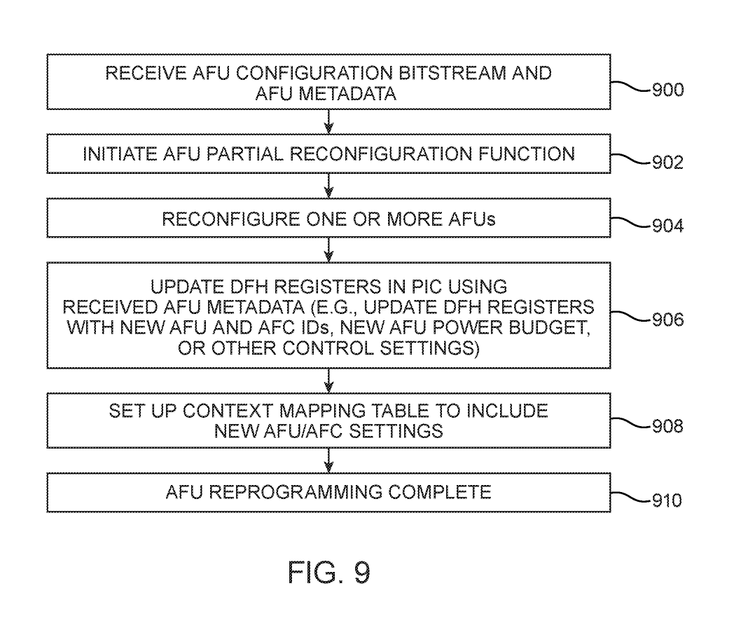

In yet another suitable arrangement, the AFU DFH and the AFC DFHs may be all implemented as programmable registers in PIC 250. In this configuration, the DFH registers may be updated in parallel along with the partial reconfiguration of each AFU. FIG. 9 is a flow chart of illustrative steps for reconfiguring an AFU. At step 900, programmable device 100 may receive an AFU partial reconfiguration bitstream and associated AFU metadata. At step 902, device 100 may initiate the AFU partial reconfiguration function to load the newly received AFU bitstream into the corresponding PR slot.

At step 904, at least one AFU is reconfigured using the AFU bitstream. Upon updating the AFU, the corresponding DFH registers in PIC 250 may be updated using the received AFU metadata (e.g., to update DFH registers with new AFU and AFC IDs, with new AFU power budget, or with other control settings). At step 908, PIC 250 may set up the context mapping table to include the new AFU/AFC settings (e.g., to optionally update the context_id if necessary). After updating the context mapping table, AFU reprogramming may be complete (at step 910).

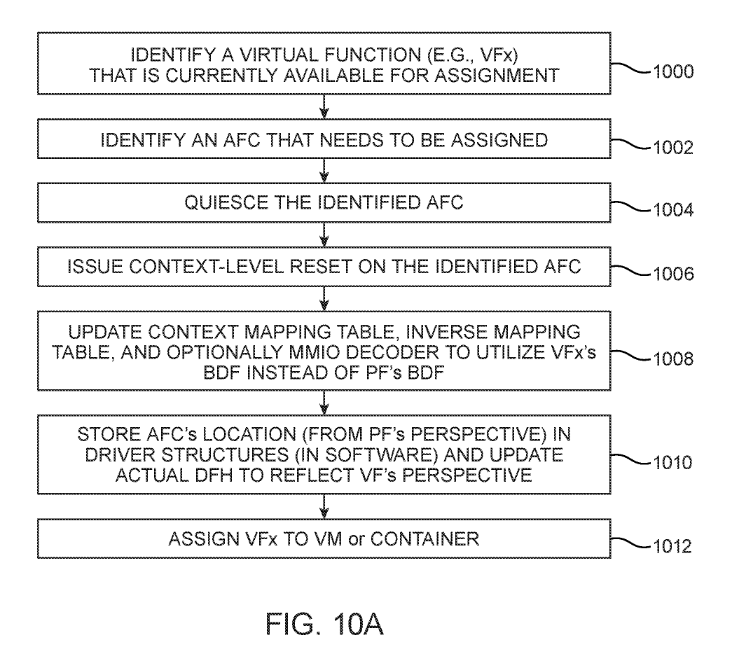

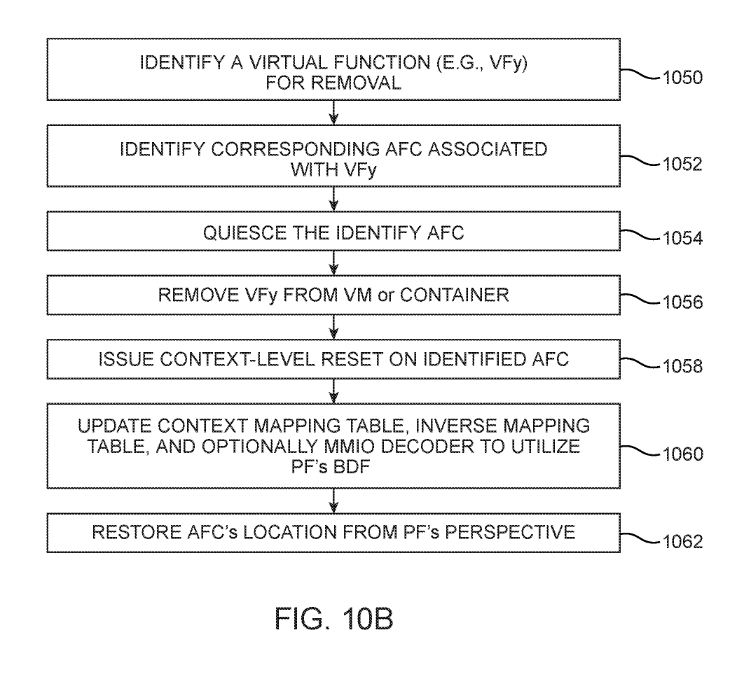

In general, the AFU/AFC identifier and location information, the context mapping tables, and other associated context-level parameters may be updated by the physical function during partial reconfiguration operations or during a VF assignment/removal process. FIG. 10A is a flow chart of illustrative steps for assigning a virtual function to a particular AFC. At step 1000, a virtual function such as VFx may be identified as a virtual function that is currently available for a new assignment.

At step 1002, an AFC that needs to be assigned to a virtual function may be identified. At step 1004, the identified AFC may be quiesced. At step 1006, a context-level reset (see FIG. 4) may be issued to the identified AFC.

At step 1008, context mapping table 260-1 (FIG. 3A), inverse context mapping table 260-2 (FIG. 3B), and optionally MMIO decoder 264 (FIG. 2) may be updated to utilize VFx's BDF number instead of PF's BDF number. In the case of Scalable IOV, the BDF number can be kept the same while only updating the PASID.

At step 1010, the AFC's location from the PF's perspective can be stored in driver structures (i.e., in software) and the actual DFH may be updated to reflect the VF's view. At step 1012, VFx may then be assigned to a virtual machine or container. In general, the steps of FIG. 10A may be performed using PIC 250 or some other control unit within the system.

FIG. 10B is a flow chart of illustrative steps for removing a virtual function from an AFC. At step 1050, a virtual function such as VFy may be identified as a virtual function that needs to be removed or de-assigned from an AFC.

At step 1052, a corresponding AFC that is associated with VFy may be identified. At step 1054, the identified AFC may be quiesced. At step 1056, VFy may be removed from the virtual machine or container that it currently resides on.

At step 1058, a context-level reset (see FIG. 4) may be issued to the identified AFC. At step 1060, context mapping table 260-1 (FIG. 3A), inverse context mapping table 260-2 (FIG. 3B), and optionally MMIO decoder 264 (FIG. 2) may be updated to utilize the PF's BDF number instead of VFy's BDF number. In the case of Scalable IOV, the BDF number can be kept the same while only updating the PASID.

At step 1062, the AFC's location may then be restored from the PF's perspective. In general, the steps of FIG. 10A may be performed using PIC 250 or some other control unit within the system.

The embodiments thus far have been described with respect to integrated circuits. The methods and apparatuses described herein may be incorporated into any suitable circuit. For example, they may be incorporated into numerous types of devices such as programmable logic devices, application specific standard products (ASSPs), and application specific integrated circuits (ASICs), microcontrollers, microprocessors, central processing units (CPUs), graphics processing units (GPUs), etc. Examples of programmable logic devices include programmable arrays logic (PALs), programmable logic arrays (PLAs), field programmable logic arrays (FPGAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The programmable logic device described in one or more embodiments herein may be part of a data processing system that includes one or more of the following components: a processor; memory; IO circuitry; and peripheral devices. The data processing can be used in a wide variety of applications, such as computer networking, data networking, instrumentation, video processing, digital signal processing, or any suitable other application where the advantage of using programmable or re-programmable logic is desirable. The programmable logic device can be used to perform a variety of different logic functions. For example, the programmable logic device can be configured as a processor or controller that works in cooperation with a system processor. The programmable logic device may also be used as an arbiter for arbitrating access to a shared resource in the data processing system. In yet another example, the programmable logic device can be configured as an interface between a processor and one of the other components in the system.

The foregoing is merely illustrative of the principles of this invention and various modifications can be made by those skilled in the art. The foregoing embodiments may be implemented individually or in any combination.

What is claimed is:

1. A system comprising:
a host processor operable to offload tasks; and
a coprocessor coupled to the host processor via a host interface, wherein the coprocessor is operable to receive the offloaded tasks and to provide hardware acceleration for the host processor, and wherein the coprocessor comprises:
a partial reconfiguration region loaded with an accelerator function unit (AFU), wherein the AFU is subdivided into a plurality of accelerator function unit contexts (AFCs); and
an interface circuit operable to map at least one of the plurality of AFCs to a corresponding host-assignable interface at least partially spanning the host interface between the host processor and the coprocessor.

2. The system of claim 1, wherein the host interface is a selected one of a Peripheral Component Interconnect Express (PCIe) interface, Cache Coherent Interconnect for Accelerators (CCIX) interface, Gen-Z interface, Open Coherent Accelerator Processor Interface (OpenCAPI) interface, Intel Accelerator Link (IAL) interface, and NVLink interface.

3. The system of claim 1, wherein the host interface is a Peripheral Component Interconnect Express (PCIe) interface that supports single-root input/output virtualization (SR-IOV) or scalable input/output virtualization (Scalable IOV).

4. The system of claim 3, wherein the host-assignable interface is a selected one of a PCIe physical function, a PCIe SR-IOV virtual function, and a PCIe Scalable IOV assignable device interface.

5. The system of claim 1, wherein the host-assignable interface is associated with a task offloading module selected from the group consisting of: a virtual machine on the host processor, a container on the host processor, and a process on the host processor.

6. The system of claim 1, wherein the plurality of AFCs are provided with unique context identifiers, and wherein transactions between the interface circuit and the AFU are tagged with the unique context identifiers to provide address space isolation.

7. The system of claim 6, wherein the interface circuit uses a context mapping table to map the unique context identifiers to platform-specific identifiers for upstream and downstream memory requests between the host processor and the plurality of AFCs and for requests initiated by the host processor to the plurality of AFCs.

8. The system of claim 7, wherein the platform-specific identifiers comprise Peripheral Component Interconnect Express (PCIe) bus, device, and function numbers and optionally a process address space identifier (PASID).

9. The system of claim 8, wherein:
the host-assignable interface comprises a PCIe physical function, and all of the AFCs in the AFU are associated with and are accessed through the PCIe physical function during a physical function (PF) mode;
the host-assignable interface comprises a PCIe virtual function, and all of the AFCs in the AFU are associated with and are accessed through the PCIe virtual function during a virtual function (VF) mode; or
at least a first portion of the AFCs in the AFU are associated with and are accessed through the PCIe physical function, and at least a second portion of the AFCs in the AFU are associated with and are accessed through the PCIe virtual function during a mixed mode.

10. The system of claim 9, wherein the interface circuit further comprises an internal table for saving the unique context identifiers, and wherein the internal table is indexed by PCIe tags automatically associated with the upstream memory requests and returned with the downstream memory requests.

11. The system of claim 9, wherein the coprocessor further comprises an address decoder configured to decode the unique context identifiers based on a memory-mapped input-output (MMIO) address associated with the host-assignable interface.

12. The system of claim 1, wherein a given AFC in the plurality of AFCs is operable to issue an interrupt to the host processor, and wherein the interrupt is tagged with a unique context identifier associated with only the given AFC.

13. The system of claim 1, wherein the coprocessor maintains a device feature list that allows the host processor to enumerate the plurality of AFCs.

14. The system of claim 13, wherein the interface circuit is managed by the host-assignable interface, and wherein the host-assignable interface has a base address register that points to the device feature list.

15. The system of claim 14, wherein the device feature list comprises a linked list of device feature headers, wherein a first of the device feature headers exposes identifier and location information associated with the AFU, and wherein a series of the device feature headers expose identifier and location information associated with the plurality of AFCs.

16. The system of claim 15, wherein the identifier and location information associated with the AFU and the plurality of AFCs is stored in programmable registers within the interface circuit.

17. The system of claim 15, further comprising an external memory coupled to the host processor, wherein the identifier and location information associated with the AFU and the plurality of AFCs is stored in the external memory.

18. The system of claim 15, further comprising a memory coupled to the host processor, wherein the identifier and location information associated with the AFU is stored in programmable registers within the interface circuit, and wherein the identifier and location information associated with the plurality of AFCs is stored in the memory.

19. The system of claim 15, wherein the device feature headers are implemented as programmable registers within the interface circuit, wherein the host-assignable interface comprises a privileged host-assignable interface, and wherein the programmable registers are programmed using the privileged host-assignable interface.

20. The system of claim 15, wherein at least some of the device feature headers are implemented as programmable registers within of the partial reconfiguration region of the AFU.

21. The system of claim 15, wherein the host-assignable interface comprises a privileged host-assignable interface, and wherein each device feature header in the series of device feature headers can be accessed using the base address register of the privileged host-assignable interface.

22. The system of claim 15, wherein the host-assignable interface comprises an unprivileged host-assignable interface, and wherein only a subset of device feature headers in the series of device feature headers can be accessed using a base address register associated with the unprivileged host-assignable interface.

23. The system of claim 15, wherein the host-assignable interface comprises a privileged host-assignable interface that is operable to reprogram the device feature list or at least some of the device feature headers in the device feature list.

24. A method for operating a system that includes a host processor and a programmable accelerator device, the method comprising:
offloading tasks from the host processor to the programmable accelerator device;
configuring a slot on the programmable accelerator device to implement an accelerator function unit (AFU), wherein the AFU is subdivided into a plurality of accelerator function unit contexts (AFCs); and
using an interface circuit in the programmable accelerator device to map the plurality of AFCs to corresponding host-assignable interfaces and to perform a context-level reset operation on a selected AFC in the plurality of AFCs.

25. The method of claim 24, wherein the context-level reset operation is initiated via a function-level reset directed at the AFU or via management registers associated with the interface circuit.

26. The method of claim 24, further comprising:
using the interface circuit to filter transactions targeted to the selected AFC.

27. The method of claim 24, further comprising:
using the interface circuit to send a context-level reset (CLR) message to the selected AFC to direct the AFU to stop issuing requests associated with the selected AFC.

28. The method of claim 27, further comprising:
in response to receiving the CLR message from the interface circuit, using the selected AFC to return a context-level reset (CLR) acknowledgement to the interface circuit.

29. The method of claim 27, further comprising:
after sending the CLR message to the selected AFC, waiting for all outstanding upstream and downstream requests associated with the selected AFC to be flushed out before terminating the function-level reset operation for the selected AFC.

30. The method of claim 29, further comprising:
using the selected AFC to send a new context-level reset (CLR) message to another AFC in the plurality of AFCs.

31. A method for operating a system that includes a host central processing unit (CPU) and an associated acceleration device, the method comprising:
offloading tasks from the host CPU to the acceleration device; and
partially reconfiguring a slot on the acceleration device to implement an accelerator function unit (AFU), wherein the AFU is subdivided into a plurality of accelerator function unit contexts (AFCs) that map to corresponding host-assignable interfaces.

32. The method of claim 31, further comprising:
updating device feature header registers on the acceleration device with new identifier information associated with the AFU and the AFCs.

33. The method of claim 32, further comprising:
setting up a context mapping table to include the new identifier information, wherein the context mapping table maps unique context identifiers associated with the plurality of AFCs to platform-specific identifiers.
